(19) United States
(12) Patent Application Publication
(10) Pub. No.: US 2003/0019479 A1
(43) Pub. Date: Jan. 30, 2003

(54) Apparatus for improving the replicability of the injection duration on injection systems

(76) Inventors: Anja Melsheimer, Stuttgart (DE); Gerd Wille, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/130,423

(22) PCT Filed: Sep. 4, 2001
(86) PCT No.: PCT/DE01/03364

(30) Foreign Application Priority Data
Sep. 18, 2000 (DE) 10046040.2

(51) Int. Cl. F02M 51/00

(52) U.S. Cl. 123/467; 123/490; 123/499; 123/446

(57) ABSTRACT

The invention relates to an apparatus for injecting fuel, having a control valve (16) that has a valve chamber (18). From the valve chamber (18), a high-pressure line (37) leads to the injector; the valve chamber (18) also communicates with a pump chamber (23) for fuel that is at high pressure. The control part of the control valve (16) is actuatable by means of an electromagnet (17). The control valve (16) is coupled with a passive piston (20), which to avoid the pulse change, which acts on the piston (20), is provided with a bore (21).

### FIELD OF THE INVENTION

The invention relates to an apparatus for improving the replicability of the injection duration in injection systems. For triggering the control valve, which controls the duration and instant of the injection event in injection systems for fuel that is at high pressure, magnet valves are currently conventionally employed. To lessen the gradient of the injection pressure, this is not closed entirely for the boot injection or the stored pre-injection, but instead is kept in a position that is open by only a few micrometers. In that position, the magnet valve is stabilized, both by the reduced magnetic force of the magnet and by the spring force of the piston.

### PRIOR ART

To lessen the gradient of the injection pressure and to achieve a favorable course of the injection pressure during the stored pre-injection phase (boot phase), the magnet valve in this phase is never closed completely; it is then kept in an intermediate position by the magnet that triggers it.

During the booting phase, the stability of the magnet valve and thus coupled with it the attainable injection quantity and the attainable injection pressure all depend very strongly on the booting current, that is, the current to which the magnet actuating the control valve can be subjected during the booting phase. By means of complicated changes made in the hardware components of the control unit, the booting current during the booting phase can be preset with an accuracy of ±0.25 A. This tolerance is absolutely necessary, so that the required quantity tolerances for the injection quantity of the injection pumps will not be exceeded. Therefore each injection pump that is used on a mass-production basis is calibrated precisely and classified in terms of its booting current during the stored pre-injection phase. The booting current that is then individual for each injection pump is then set at the control unit, which is a very complicated process but is absolutely necessary if the requisite accuracy in metering the injection quantities is to be attained, for a booting current specification accuracy of ±0.25 A.

It has been found that once the main injection of the fuel has taken place, magnet valves, upon opening, exhibit a pronounced recoil behavior. This makes the nozzle needle that performs the injection oscillate, which makes replicability of the injection events, and especially of the fuel quantity injected, more difficult. In certain load situations, post-injections can even occur, which is extremely undesirable.

### SUMMARY OF THE INVENTION

The advantages associated with the embodiment proposed according to the invention are considered to be above all that with the design of the passive piston according to the invention, a piston that is required for the boot injection, the recoil behavior of the magnet valve at the end of the main injection can be varied quite positively. If the current supply to the magnet is switched off at the end of the main injection, then the magnet valve opens by means of the magnet valve spring. In the low-pressure circuit around the magnet valve, pressure pulsations occur. They can cause the passive piston to press the magnet valve closed again somewhat, and accordingly a post-injection can occur at various load points. This can be eliminated by the transverse bore in the wall of the passive piston. The result is improved stability and replicability of the injection duration; both of these are influenced decisively by the improvement in the recoil behavior of the magnet valve.

By means of the transverse bore provided in the passive piston, the pulse change at the magnet valve during the booting phase of the injection system can also be improved. Thus when the embodiment proposed according to the invention is employed during the booting phase of the injection system, a booting current accuracy of ±0.5 A can already suffice. Increasing the tolerance window from 0.25 A to 0.5 A of booting current accuracy opens up the possibility of keeping hardware changes to the control unit of the injection system within limits and thus saving on design costs.

When the control valve (with a transverse bore) designed according to the invention is employed, a booting current accuracy of ±0.5 A suffices to keep the magnet valve in a stable booting phase. As a result of the changes made in the control valve of the injection system, the injection pumps now no longer need to be calibrated for an individual booting current; instead, only a calibration of the injection pumps with respect to a booting current window is necessary, which means a considerable reduction in terms of measurement effort and expense and measurement time.

If using an injection valve in the context of a booting current window is allowable, then it is possible to dispense with setting an individual booting current during the pre-injection phase at the control unit of the injection system. Moreover, when injection pumps are replaced, it is no longer necessary to change the control unit setting when using the control valves, designed according to the invention, that have passive pistons.

### DRAWINGS

The invention is described in further detail below in conjunction with the drawing.

Shown are:

FIG. 1, the courses of the magnet valve stroke of the current of the electromagnet for the magnet valve, and the nozzle pressure course, each plotted over the crankshaft angle, the nozzle needle stroke, and the injection rate; after the main injection, the magnet valve stroke exhibits a significant recoil behavior;

FIG. 2, a schematic arrangement of the components of an injection system whose control valve comprises a magnet valve and a passive piston, and the magnet valve, for forming the boot injection, is coupled with a passive piston;

FIG. 3, the design of the passive piston; and

FIG. 4, the courses of the magnet valve stroke, the current of the electromagnet for the magnet valve, and the nozzle pressure course, nozzle needle stroke and injection rate, each plotted over the crankshaft angle, when a control valve modified according to the invention is employed.

### VARIANT EMBODIMENTS

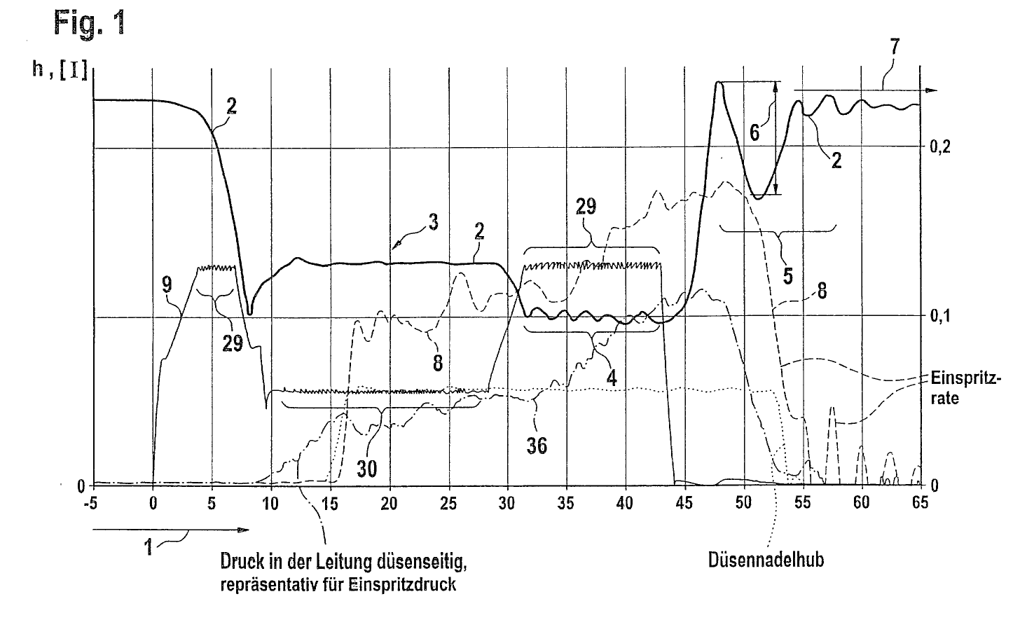

From the graph in FIG. 1, the courses of the magnet valve stroke of the current controlling the electromagnet of the magnet valve, and the resultant nozzle needle pressure can be seen.

Reference numeral 1 identifies the continuously plotted crankshaft angle; reference numeral 2 identifies the course of the magnet valve stroke path. Reference numeral 8 identifies the course of the injection rate, reference numeral 36 designates the course of the pressure, and reference numeral 9 designates the course of the current applied to the electromagnet in each case.

The magnet valve, which is in the open state, is moved from its open position to the closed position by the electromagnet, which is subjected to a current at a first current level 29. As a consequence, the passive piston also executes a stroke, the stroke of the piston being shorter than the stroke of the magnet valve. By reduction of the current level to a second current level 30, the magnet valve opens and moves into the intermediate position. The magnet valve and the passive piston are now coupled with one another (the stroke of the magnet valve is equivalent to the stroke of the piston).

This control event represents the onset of the booting phase 3 of the injection valve. During this phase, the pressure increase 36 has only a slight gradient. The end of the pre-injection phase 3 is effected by triggering the electromagnet that controls the control valve 16, the triggering being done at a first current level 29. During the main injection phase, the pressure increases in triangular fashion. The main injection phase, represented by reference numeral 4, in the curved courses shown in FIG. 1 is ended at a crankshaft angle of approximately 45°; the electromagnet of the control valve becomes currentless, and the magnet valve returns to its open state. In the embodiments known until now from the prior art, an amplitude marked by reference numeral 6 then occurs, which identifies an unwanted coil behavior after the opening of the magnet valve. Accordingly, the magnet valve does not return directly to its resultant steady state, marked by reference numeral 7, but instead induces oscillations in the injection system that in an extreme case, at certain load points of the injection system, leads to after-injections at the nozzle needle valve, which are extremely undesirable in the operation of an internal combustion engine.

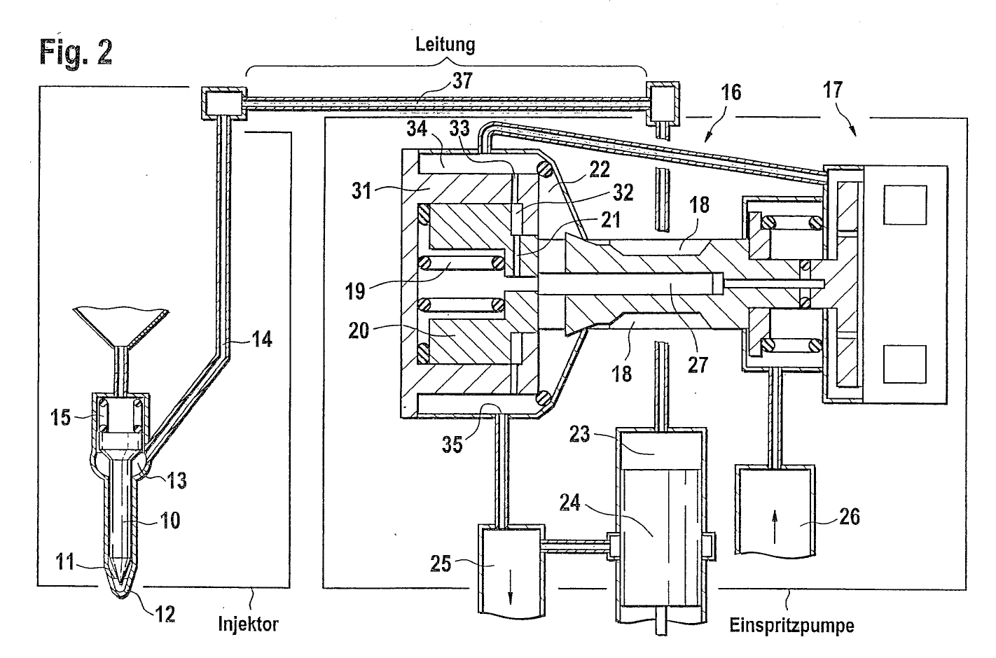

From the illustration in FIG. 2, the components of an injection system can be seen schematically.

From a control valve 16, which includes an electromagnet 17 that triggers it, the high-pressure line 37 extends from the valve chamber 18 as far as the injector. Adjoining it, the bores in the injector lead to the upper nozzle chamber 13. The nozzle needle 10, acted upon by a spring element supported on the nozzle housing, extends into the combustion chamber of an internal combustion engine and includes a nozzle seat 11, by the uncovering of which the fuel, which is at high pressure, is injected in the form of an injection cone 12 into the combustion chamber of a cylinder of an internal combustion engine.

The valve chamber 18 likewise communicates with the pump chamber 23. If the entire high-pressure system is filled with fuel, then the fuel is brought to high pressure by means of the pump piston 24, as a function of the feed rate, rpm and magnet valve position. The control valve 16 furthermore communicates in the pump housing with a return line for fuel, via a branch 35.

The pump housing also has a further fuel supply line, identified by reference numeral 26 in the view of FIG. 2.

The magnet valve 16 is coupled to a passive piston 20. The piston 20 is acted upon by a compression spring 19, which is braced on the housing part 21, surrounding the piston 20, of the pump housing 22. The piston 20 is penetrated by a through bore, which is disposed coaxially to the bore 27 that penetrates the control part of the control valve 16. The bore 21 in the passive piston 20 is preferably designed as a transverse bore and connects the through bore of the piston 20 with a hollow chamber 32 that the piston 20 and the valve stop 31 form. From the hollow chamber 32, an outlet bore 33 through the valve stop branches off into the surrounding hollow chamber 34. Communicating with this hollow chamber 34 is the return line 25 for the fuel, via a branch 35; a return line into the region of the electromagnet 17 also branches off from the hollow chamber 34 inside the pump housing.

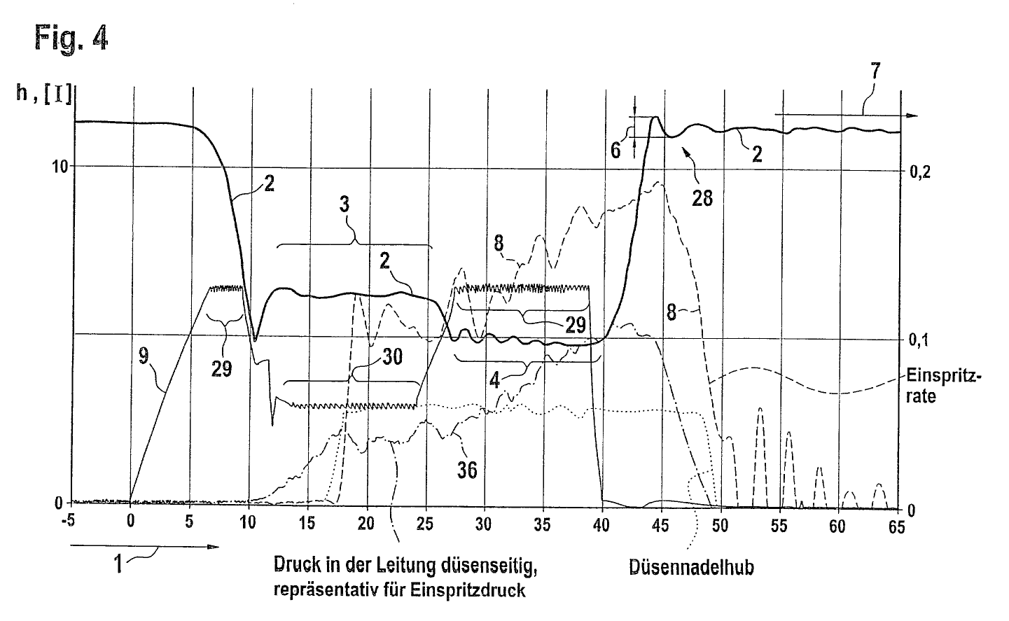

The transverse bore 21 in the passive piston has a diameter of only a few millimeters, in the range from 2 to 3 mm and preferably approximately 2.4 mm, and has the effect that when the electromagnet 17 is currentless, once the main injection phase 4 has taken place (see FIG. 1), a pressure equilibrium is accomplished in the hollow chamber 32 and in the passive piston. The passive piston is now pressure-compensated and hence cannot push against the valve and cause it to recoil (compare the state marked 6 in FIG. 4 with that in FIG. 1).

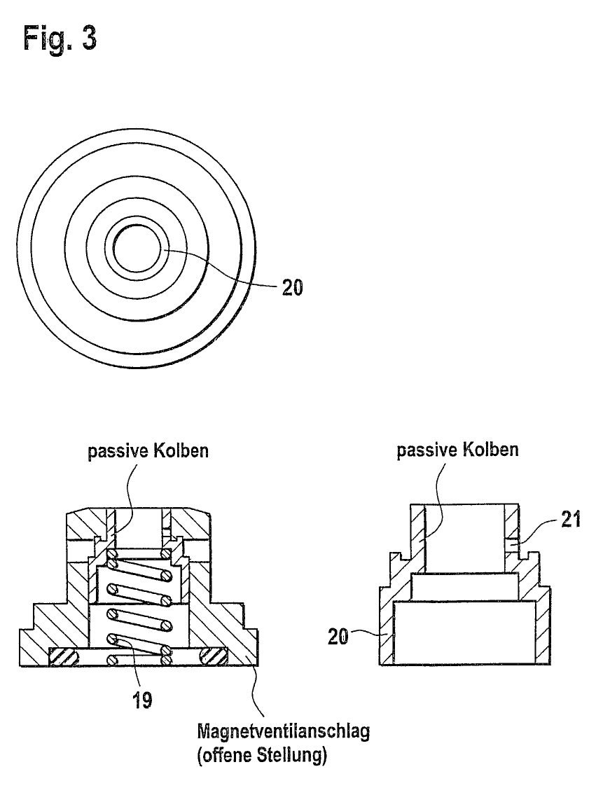

From the view shown in FIG. 3, the configuration of the valve stop 31 and the piston 20 can be seen in greater detail.

Inside the valve stop 31, which has a bore 33 for connecting the hollow chamber 32 to the hollow chamber 34, the passive piston 20 is acted upon via a compression spring 19 and in its tapered region includes a transverse bore 21, preferably with a diameter of only a few millimeters, approximately 2 to 3 mm, that penetrates the piston wall. The transverse bore 21 connects the through bore in the piston 20, via a hollow chamber 32 (see FIG. 2), with a bore 33 in the valve stop 31, the latter surrounding the piston 20 and thus assuring that the passive piston is pressure-balanced.

From the graph in FIG. 4, the magnet valve stroke path 2, the course of the current 9 to which the electromagnet 17 is subjected, and the pressure course 36 that ensues in the line can be seen in further detail.

During the main injection phase 4, during which the electromagnet 17 of the control valve 16 is triggered with the current, which is at a first current level 29, the electromagnet 17 is made currentless at a crankshaft angle of approximately 40°. As a consequence, the magnet valve moves from its closed position during the main injection phase 4 into its opened position 7; now, as a shown in FIG. 4, the magnet valve recoils only slightly, or possibly not at all (stroke signal by means of optical sensor) and moves into its open position. This recoil 28 is characterized in the magnet valve stroke path 2 by the amplitude 6, which is markedly reduced compared to what FIG. 1 shows. When the passive piston with the transverse bore in the control valve 16 is used, a markedly smoother magnet valve stroke path thus ensues, which virtually precludes the recoil behavior and definitively precludes the incidence of unwanted post-injections at the nozzle needle 10.

A control valve 16, provided with the piston 20 according to the invention and the transverse bore 21, in principle has a markedly higher meterability and controllability of the injection quantities and the instants of injection of fuel that is at high pressure for the booting phase. When the control valve designed according to the invention is used, it is now possible to allow booting current windows of only ±0.5 A, rather than the tolerance range of ±0.25 A, during the pre-injection phase 3 (booting phase). As a result, the changes to be made in the control unit of the injection system in terms of the tolerances of the booting current can be reduced substantially, which makes for a major cost saving.

Optionally, as an alternative to using the piston 20, proposed according to the invention, in the control valve 16 and while guaranteeing a booting current tolerance of ±0.5 A, the complicated, time-consuming calibration of injection pumps for individual booting currents can be dispensed with, since now calibration has to be done only with respect to booting current windows rather than to individual booting current values, which allows the use of a substantially simpler measuring method. Moreover, individual booting currents may no longer need to be set separately at the control units, so that at overall lower cost, substantially more-accurate replicability and stability of the injection duration in injection systems are attainable.

1. An apparatus for injecting fuel, having a magnet valve (16) which includes a valve chamber (18), from which a high-pressure line (37) extends to the injector and which communicates with a pump chamber (23), and the magnet valve (16) is actuatable by means of an electromagnet (17), characterized in that the magnet valve (16) includes a passive piston (20), which includes a bore (21) for avoiding the pulse change that acts on the piston (20).

2. The apparatus of claim 1, characterized in that the bore (21) is embodied transversely to the direction of motion of the piston (20), in the wall of the piston.

3. The apparatus of claim 1, characterized in that the bore (21) connects a through bore (27) of the control valve (16) with a hollow chamber (34) in the pump housing (22).

4. The apparatus of claim 3, characterized in that a return line (25) for fuel branches off from the hollow chamber (34) of the pump housing (22), into which chamber the bore (21) discharges.

5. The apparatus of claim 1, characterized in that the bore (21) penetrates the piston (20), which forms the injection course, in a region in which the piston (20) is embodied with a smaller outer diameter.

6. The apparatus of claim 1, characterized in that the valve stop (31) surrounding the piston (20) includes an outlet bore (33), which connects the hollow chamber (32), between the housing (31) and the piston (20), with the return-side hollow chamber (34) of the valve housing (22).

7. The apparatus of claim 1, characterized in that the passive piston (20) is acted upon in the valve stop (31) by a compression spring (19).

8. The apparatus of claim 1, characterized in that the bore (21) has a diameter of a few millimeters.

9. The apparatus of claim 8, characterized in that the bore (21) has a diameter between 2 and 3 mm.
